(19) United States
(12) Patent Application Publication
(10) Pub. No.: US 2006/0113999 A1
(43) Pub. Date: Jun. 1, 2006

(54) Precision timing light for internal combustion engine and method of use

(76) Inventors: Paul Brothers, Memphis, TN (US); Ron Turnpaugh, Olive Branch, MS (US)

Correspondence Address: ARENT FOX PLLC, 1050 CONNECTICUT AVENUE, N.W., SUITE 400, WASHINGTON, DC, 20036, US

(21) Appl. No.: 10/998,642

(22) Filed: Nov. 30, 2004

(51) Int. Cl. F02P 17/00

(52) U.S. Cl. 324/391

(57) ABSTRACT

An ignition timing device for measuring ignition timing that includes a focused light source, a securing member, an ignition indication sensor, and a control box. The focused light source permanently or removably attaches to an engine or engine compartment in close proximity to a rotating portion of the engine having marks that, when aligned with fixed timing marks or a reflection point, indicate ignition timing. The ignition timing device flashes the focused light source in response to receiving ignition detection signals from the ignition indication sensor. The control box has a capability to advance or retard the flashing of the focused light source in response to the ignition signal to allow advance or retard of engine ignition timing through, for example, adjustment to the distributor of the engine.

### BACKGROUND OF THE INVENTION

1. Field of the Invention

This invention relates to a timing light for use with an internal combustion engine to accurately measure ignition timing, particularly a timing light having a focused light source permanently or removably attached onto or near an engine for which timing information is desired.

2. Discussion of Related Art

As an internal combustion engine operates, pistons slidable within one or more cylinders cause a crankshaft within the engine to rotate by means of connecting rods attached both to the pistons and the crankshaft. In internal combustion engines of the gasoline type, the pistons compress an air/fuel mixture while moving toward an end of the cylinders. A spark plug then ignites the air/fuel mixture, causing the piston to slide down the cylinder, thereby rotating the crankshaft. Ignition timing refers to the location of a piston within a cylinder relative to the instant the spark plug fires. Ignition retard is ignition occurring after the piston has passed top dead center, whereas ignition advance is ignition that occurs before the piston reaches top dead center.

Conventionally, one method of measuring ignition timing has been to illuminate a timing mark provided on a periphery of a rotating engine component, usually a pulley, at the instant an engine spark plug fires. At the moment the light flashes, the illuminated timing mark on the pulley appears stationary and is compared to scale marks on the engine proximate to a periphery of the rotating engine component. Ignition timing can then be determined by comparing the mark on the pulley and the marks on the engine block. Ignition timing can thereafter be adjusted to correspond to a predetermined specification.

One example of an illumination timing device is U.S. Pat. No. 4,713,617 issued to Michalski. The Michalski reference discloses a hand-held digital timing light that includes a pistol-type housing, a lamp mounted therein, and a pickup cable that attaches to a portion of an engine to sense engine ignition. Once the pickup cable is connected to the engine, a user aims the device at an area of the engine where a rotating member is located, with an indicator mark adjacent to a scale fixably attached to a stationary portion of an engine. The lamp flashes at an instant related to engine ignition, and ignition timing is measured by the position of the indicator mark relative to the scale.

Another example is U.S. Pat. No. 5,610,327 issued to Becker, et al., which relates to a hand-held ignition timing device for measuring diesel ignition timing. The Becker reference discloses the use of both a visible laser diode and a xenon lamp housed within a pistol-shaped housing. The visible laser diode emits a beam of visible laser light to illuminate a reflective tape adhesively provided on a periphery of a flywheel. A photodiode within the housing detects the beam of visible laser light reflected from the reflective tape, informing a control circuit of the location of a piston within an engine cylinder. The device also includes a knock sensor located in close proximity to the engine cylinder being used to measure ignition timing. The knock sensor detects vibration caused by combustion within a cylinder. Once the photodiode detects visible laser light reflected from the reflective tape, the device identifies the impending combustion within the cylinder and prepares to flash the xenon lamp. The xenon lamp flashes once the device receives the next signal from the knock sensor. The visible laser diode and reflective tape are necessary because diesel engines do not have ignition wires or spark plugs. Therefore, the device must be able to discriminate between vibrations that are the result of combustion in the cylinder being used to determine ignition timing and that due to other engine cylinders. Ignition timing is measured at the instant the xenon lamp flashes by the position of a timing mark on the flywheel relative to scale marks on a stationary part of the engine adjacent to the flywheel.

One problem associated with hand-held devices such as Michalski and Becker is that the ignition timing perceived by an observer will vary from the true ignition timing, because, for example, the user observes the shadows cast by the timing and scale marks due to lighting effects associated with the handheld device, rather than the marks themselves, when determining timing. Additionally, the locations of the shadows cast by the marks change, even if only by a slight amount, due to a change in position of both the light source and the observer each time a measurement is made. Therefore, because both the handheld device and the observer can be positioned at any location, the handheld devices impart a large amount of error in measuring ignition timing. This error can be detrimental to the proper function and performance of modern engines because of the extreme precision with which modern internal combustion engines are designed.

Another example is U.S. Pat. No. 3,857,086 to Mooney, et al., which relates to a process for establishing ignition timing for a reciprocating internal combustion engine. The patent discloses a transducer inserted into a socket fixably attached to an engine block. The transducer generates an electrical signal whenever a groove located on a circumferential edge of a vibration damper travels past the transducer. A clamp attaches to an ignition cable, sensing an ignition signal therein. A comparator circuit compares the two signals to determine ignition timing.

An additional example is U.S. Pat. No. 6,429,658 to Thomsen, et al., which relates to an ignition timing device for an internal combustion engine. Thomsen discloses a sensor secured proximate to a timing port and a timing mark provided on a periphery of a pulley. The sensor creates a timing mark signal when the timing mark passes the sensor, as the pulley rotates. Also disclosed is an ignition sensor that creates an ignition signal indicative of the occurrence of an ignition spark. The ignition sensor can take the form of an inductive clamp or a timing light and a light detector. A comparator receives both the timing mark signal and the ignition signal and provides an output signal indicative of the time difference between those signals.

Devices such as those disclosed by Mooney and Thomsen, while having a sensor fixed in some fashion to an engine, do not disclose the use of a highly focused and accurate timing measurement mechanism. Further, with the prior art, a user is precluded from directly observing ignition timing by referencing the location of a timing mark on a rotating engine component relative to a mark fixed to the stationary engine.

### SUMMARY OF THE INVENTION

The ignition timing device of the instant invention solves the problems identified above, as well as others, by having a focused light source fixed at a single position in close proximity to a portion of an engine where ignition timing is measured, along with retard/advance functionality permitting the use of an indicator mark, located, for example, on a rotating member of the engine, for measuring ignition timing and providing a precise retard or advance of ignition timing.

According to a first aspect of the invention, the ignition timing light includes a focused light source, a securing member to permanently or removably fix the light source to the engine or engine compartment, an ignition indication sensor, a varying indication locator, such as a mark on a rotating engine member, and a control box having a readout and a retard/advance functionality to manipulate when the focused light source flashes. A narrow, focused light beam emitted from the focused light source provides for precise alignment of the reflected beam with the locator provided on the rotating engine member. Also, because the securing member fixes the focused light source at a single location, measurement error caused, for example, by lighting effects associated with traditional handheld timing devices having omnidirectional light sources is reduced.

According to a second aspect of this invention, the ignition timing light of the instant invention includes a secondary light source permanently or removably attached with the focused light source. In one variation, the secondary light source flashes in unison with the focused light source and improves the ignition timing measurement when the measurement is made for example, under bright ambient conditions or at other times when illumination of the locator is obscured. The secondary light source allows an observer to view the locator on the rotating engine component when the apparent stationary position of the locator is not coincident with the beam emitted from the focused light source.

According to a third aspect of the invention, the focused light source, the control box, and the ignition indication sensor communicate via a wired, wireless, or fiber optic link.

Additional advantages and novel features of the invention will be set forth in part in the description that follows, and in part will become more apparent to those skilled in the art upon examination of the following or upon learning by practice of the invention.

### BRIEF DESCRIPTION OF DRAWINGS

Other aspects of the present invention will be better understood from the following description, along with the accompanying drawings, wherein:

FIG. 1 is a perspective view of an exemplary precision timing light of the present invention disposed in an engine compartment;

FIGS. 2A-2C provide detailed views of an area of an engine block on which a light assembly, in accordance with the present invention, is attached and operating;

FIG. 3 is an exploded view of a light assembly for an embodiment of the present invention; and

FIG. 4 is a perspective view of a control box in accordance with an embodiment of the present invention.

### DETAILED DESCRIPTION OF THE INVENTION

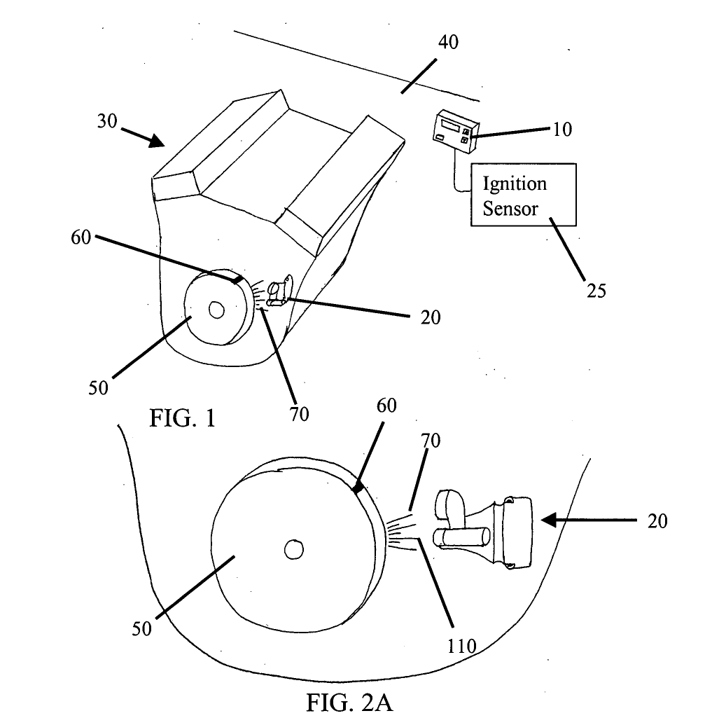

The present invention relates to an ignition timing device for measuring the ignition timing of an internal combustion engine, an embodiment of the present invention comprising a control box 10, a light assembly 20, and an ignition indication sensor 25. The control box 10, light assembly 20, and the ignition indication 25 sensor communicate, for example, via a wired, wireless, or fiber optic link, and are powered, for example, via an internal power source, such as an internal battery, or via connection to a vehicle battery. FIG. 1 illustrates an engine compartment having an engine 30 and a firewall 40. In this embodiment, the control box 10 is fixably located within the engine compartment. It is within the scope of the present invention, though, that the control box 10 could be located at any location or be usable remotely, such as in a hand-held device. A rotating engine member or other component 50, such as a standard pulley, is attached to an end of or otherwise rotates via a crankshaft contained within the engine 30 (i.e., as the crankshaft rotates, the rotating engine member 50 correspondingly rotates). Additionally, a timing light assembly 20 attaches to the engine 30 proximate to the pulley 50.

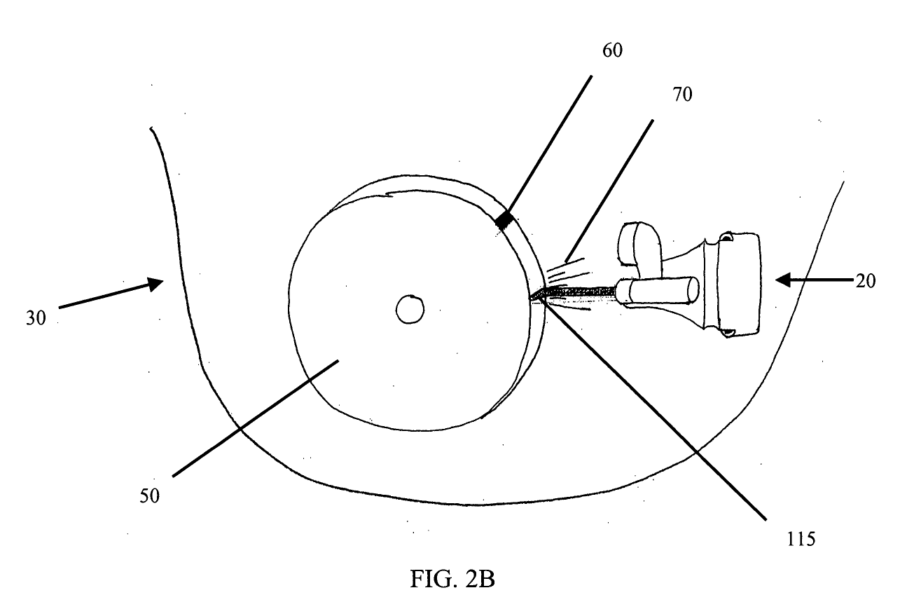

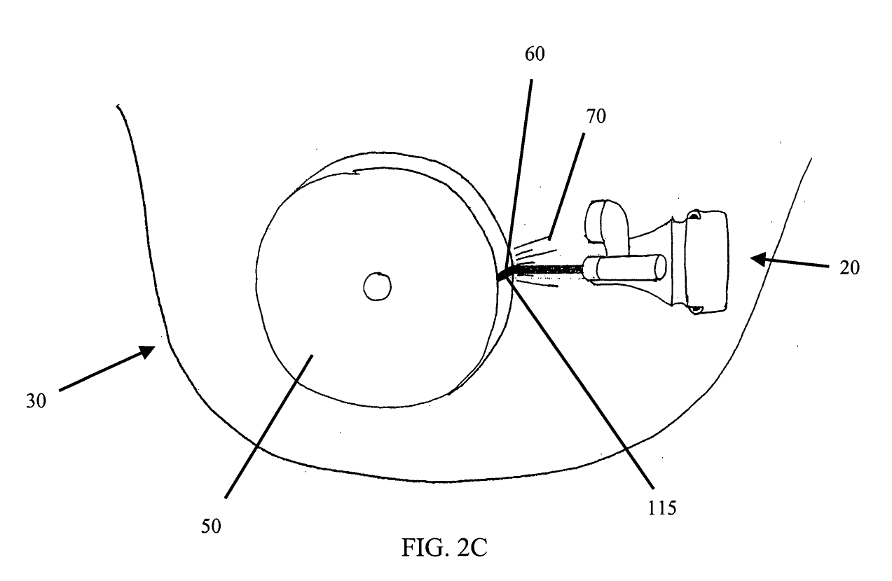

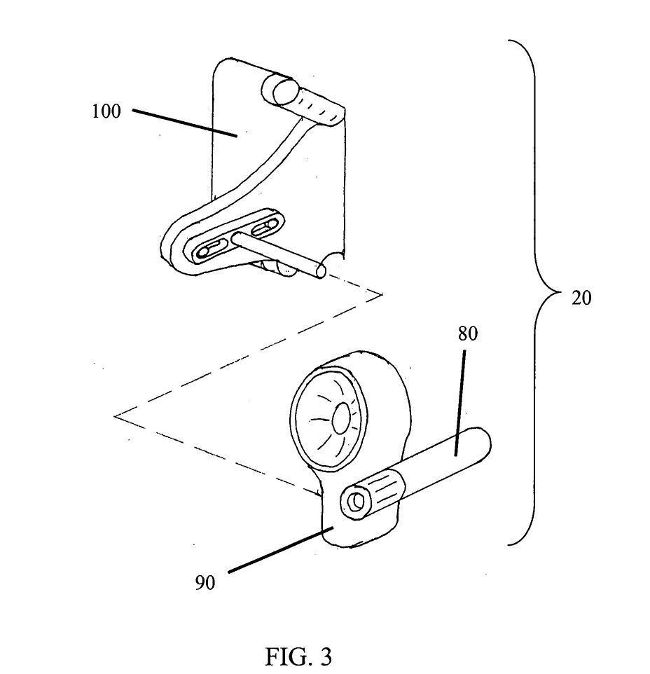

FIG. 2A is a detailed view showing the rotating engine member 50, an indicator 60, such as a timing mark, provided on an outer periphery of the rotating engine member 50, optional scale marks 70 provided on the engine 30, and the light assembly 20. As illustrated in FIG. 3, the light assembly 20 comprises a focused light source 80 and a mounting bracket 100. In one embodiment, the focused light source 80 is a laser. Also, the light assembly 20 optionally includes a secondary light source 90, such as a diffused stroboscopic light or a continuous diffused light source to provide general illumination. In one embodiment, the secondary light source 90 is an ultra bright white light emitting diode. The light assembly 20 permanently or removably attaches to the engine 30 or some other location within the engine compartment proximate to the rotating engine member 50, for example, with bolts. Further, optionally, the light assembly 20 attaches such that a narrow, focused light beam emitted from the focused light source 80 precisely aligns, for example, with one of the scale marks 70 provided on the engine 30, identified as reference mark 110. It is noted, however, that when the fixed focused light assembly 20 is used with the control box 10 that adjusts for variation in ignition advance and retard, no such fixed marks are required.

Additionally, the ignition timing device of the instant invention includes a retard/advance functionality to advance or retard when the focused light source 80 flashes relative to engine ignition. The retard/advance functionality allows, for example, for the elimination of scale marks 70 when measuring ignition timing, rather than requiring determination of the apparent location of the indicator 60 relative to any one of the scale marks 70. Alternatively, a single reference mark 110 may be used. An example of a method for delaying the flash signal is disclosed in U.S. Pat. No. 5,767,681 issued to Huang, the contents of which are hereby incorporated by reference in their entirety.

In operation, the ignition indication sensor 25 senses ignition via, for example, a spark plug wire of the engine 30, and transmits a corresponding ignition detection signal to the control box 10. In response, the control box 10 transmits a flash signal to the light assembly 20. The flash signal causes the focused light source 80 to emit a brief narrow, focused light beam that projects onto the outer periphery of the rotating engine member 50 creating a narrow, focused reflection point 115, with the focused reflection point 115 either being coincident with the position of the indicator 60 or at a location ahead or behind the indicator 60, relative to rotation of the member 50. Even when the engine is idling, numerous ignitions signals occur over a short period of time. In response, the focused light source 80 flashes rapidly, making indicator 60 appear to be stationary relative to the reflection point 115 on the outer periphery of the rotating member 50 (see further description below with regard to FIGS. 2B and 2C).

Optionally, the secondary light source 90 flashes in unison with the focused light source 80, improving the ignition timing measurement when the indicator 60 initially falls far from the reflection point 115 of the focused light beam (e.g., to create an enhanced reflection from the indicator 60, thereby highlighting the location of the indicator 60 relative to the reflection point 115 of the focused light beam) or, for example, when ignition timing measurements are being made in bright ambient light conditions or other conditions necessitating enhancement of the location of the indicator 60. In one embodiment, the stroboscopic function may be enabled or disabled, such as via a switch located at the control box 10 or at the light assembly 20.

In another embodiment, the secondary light source 90 operates continuously (i.e., non-stroboscopically) to provide general illumination of the timing light area.

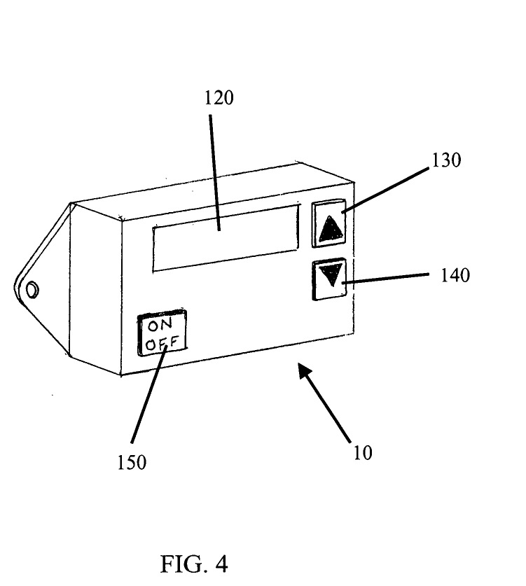

FIG. 4 shows the control box 10 having a readout 120, buttons 130 and 140, and power button 150. The power button 150 switches the control box 10 either on or off. The buttons 130 and 140 are used to adjust the retard/advance functionality, i.e., the duration of the retard/advance between the spark signal and the flash signal. The readout 120 indicates, for example, the degrees of advance or retard.

In operation, the retard/advance of the engine 30 is adjusted (e.g., by advancing or retarding ignition) until the indicator 60 aligns with the reflection point 115 for the light beam, as shown in FIG. 2C. By comparison FIG. 2B shows the indicator 60 non-aligned with the reflection point 115. In the situation of FIG. 2B, assuming clockwise rotation of the rotating member 50, the location of the indicator 60 relative to the reflection point 115 of the focused light beam shows ignition timing to be advanced relative to the selected timing. Adjustment of the engine ignition (e.g., by retarding ignition) would then follow until the reflection point 115 aligns with the indicator 60.

In one embodiment, a selected amount of ignition advance or retard (e.g., measured in degrees) may be input to the control box 10 (e.g., as shown in FIG. 1) by the user. The signal from the control box to the light assembly 20 is then automatically delayed or advanced such that, when the reflection point 115 aligns with the indicator 60, the selected amount of advance is incorporated into the aligning result. Alternatively, a scale, for example, the visible scale 70 shown in FIGS. 2B-2C, may be used in conjunction with the present invention to determine ignition advance or retard, from the reflection point 115 (e.g., each scale mark represents one degree of advance or retard; engine advance or retard is adjusted until the indicator 60 aligns with the selected degree advance or retard mark corresponding to the advance or retard selected).

The ignition timing light of the instant invention increases the accuracy of measuring ignition timing over the prior art in at least the following ways. First, the focused light beam emitted from the focused light source establishes an extremely narrow reflection point with which the indicator aligns when the timing selected is reached, in contradistinction to omnidirectional stroboscopic light sources typically used in the prior art. Second, the focused light beam stands in sharper contrast to the ambient conditions, permitting the observer to more easily align the indicator. Third, the closeness of the light assembly to the outer periphery of the pulley reduces or entirely eliminates shadows or other inaccuracies created by standard illumination of the indicator and the scale marks. This closeness permits the observer to align the indicator, rather than the shadow formed thereby. Error associated with shadows is further reduced because the light incident upon the outer periphery of the pulley is always emitted from the same location relative to the pulley.

Example embodiments of the present invention have now been described in accordance with the above advantages. It will be appreciated that these examples are merely illustrative of the invention. Many variations and modifications will be apparent to those skilled in the art.

1. A device for precisely measuring ignition timing, the device comprising:
a focused light source;
a securing member to fixedly locate the focused light source;
an ignition indication sensor;
a moving indicator visible relative to the focused light source; and
a control box for variably outputting a timing output to the focused light source.

2. The device of claim 1, wherein the focused light source comprises laser light.

3. The device of claim 1, wherein the focused light source, the ignition indicator sensor, and the control box communicate via a coupling.

4. The device of claim 3, wherein the coupling is selected from a group consisting of a wire, a wireless signal, and a fiber optic link.

5. The device of claim 1, wherein the securing member is attached to an engine.

6. The device of claim 1, wherein the securing member is attached within an engine compartment of a vehicle.

7. The device of claim 1, wherein the control box includes at least one input feature for varying the timing output of the focused light source.

8. The device of claim 1, wherein the control box is fixedly located within an engine compartment of a vehicle.

9. The device of claim 1, wherein the control box is a hand-held device.

10. The device of claim 1, further comprising:
a secondary light source for illuminating the moving indicator.

11. A device for precisely measuring ignition timing, the device comprising:
a focused light source comprising a laser directable at a rotating engine member, the rotating engine member having an indicator;
a secondary illuminating light source comprising an ultra bright white light emitting diode;
a securing member to fixedly locate the focused light source and the illuminating light source from a fixed engine or engine compartment location;
an ignition indication sensor; and
a control box that includes a readout for indicating the timing advance or retard of an internal combustion engine and an advance/retard functionality to advance or retard when the focused light source flashes relative to the indicator.

12. The device of claim 11 wherein the focused light source, the secondary illuminating light source, the ignition indicator sensor, and the control box communicate via a coupling.

13. The device of claim 12 wherein the coupling is selected from a group consisting of a wire, a wireless signal, and a fiber optic link.

14. A timing light device for a combustion engine, the device comprising:
means for receiving an ignition signal for a cylinder of the combustion engine;
means for transmitting an output signal based on the received ignition signal;
means for variably providing a focused light output corresponding to the output signal from a fixed location relative to the combustion engine; and
means for determining ignition timing for the combustion engine using the focused light output.

15. The device of claim 14, wherein the means for determining ignition timing includes at least one moving indicator for the combustion engine.

16. A method for measuring ignition timing, the method comprising:
sensing ignition for an internal combustion engine;
upon sensing the ignition, transmitting an ignition detection signal to a control box;
transmitting a light signal to a fixed position focused light source, the light signal corresponding to the sensed ignition; and
the fixed position light source directing a light output corresponding to the light signal to a rotating engine member, the rotating engine member including an indicator for determining the ignition timing via comparison with a reflected image for the light signal.

17. The method of claim 16, further comprising:
receiving an advance or retard input;
wherein the received input is variable, the received variable input producing variation in the light signal, the variation in the light signal thereby varying the light output.

18. A timing device, comprising:
a sensor for sensing ignition for an internal combustion engine;
a control box coupled to the sensor, the control box receiving the sensed ignition and outputting a signal corresponding to the sensed ignition;
a fixed position focused light source coupled to the control box, the light source receiving the control box output signal and outputting a focused light beam in response to the received control box output signal;
wherein the focused light beam is directed at a rotating engine member to produce a reflected image at a location on the rotating engine member, wherein the rotating engine member includes an indicator, the indicator position being comparable to the location of the reflected image so as to indicate ignition timing.

19. The timing device of claim 18, further comprising:
a secondary light source for providing illumination of the rotating engine member and the indicator.

20. The timing device of claim 19, wherein the control box includes a switch for enabling and disabling the secondary light source.
